(19) United States
(12) Patent Application Publication
(10) Pub. No.: US 2022/0120000 A1
(43) Pub. Date: Apr. 21, 2022

(54) SYSTEMS, METHODS, AND APPARATUSES FOR REMOVING THREAD FROM A SEWN SEAM

(71) Applicant: Cindy Needham, Chico, CA (US)

(72) Inventor: Cindy Needham, Chico, CA (US)

(21) Appl. No.: 17/208,555

(22) Filed: Mar. 22, 2021

Related U.S. Application Data
(60) Provisional application No. 63/092,507, filed on Oct. 16, 2020.

(51) Int. Cl. D05B 89/00; B25B 9/02

(52) U.S. Cl. CPC D05B 89/00; D05D 2305/50; B25B 9/02

(57) ABSTRACT

The present set of embodiments relate to systems, methods, and apparatuses for sewing and quilting. More specifically, the present disclosure includes embodiments for seam removal from fabric(s) including cutting and removing threads in stitching. The systems, methods, and apparatuses include increasing efficiency of stitch removal by allowing a thread cutter and thread removal tool to be combined in a single tool that can actuate between a first position and a second position allowing for easy storage and customization of the in-use configuration of the tool to each individual sewer or quilter. Additionally, the present set of embodiments creates a tool that can be stored easily when not in use.

### FIELD

The present disclosure generally relates to sewing and quilting. More specifically, devices and methods for removal of unwanted seams in fabric and methods of manufacturing such a device.

### BACKGROUND

A sewer or quilter who wishes to remove seams in fabric typically uses a sharp blade of some kind to cut the thread and then uses fingers or another device such as tweezers to pull the thread from the fabric.

Historically, the standard has been use of a seam ripper which usually includes a handle of some kind projecting point connected to a recessed blade. The user then positions the point between the thread and the fabric to draw up the stitch and then moves the device in a forward and away motion allowing the blade to slice through the thread without damaging the fabric. Loose threads are left where the stitches used to be, so the sewer then has to manually remove the threads from the fabric using their fingers or tweezers. A sewer or quilter may need to remove hundreds or even thousands of stitches during a single project and over a lifetime a large amount of time is wasted by having to switch between tools.

Some innovation has occurred in the field where a seam ripper and tweezers have been attached to one another in a fixed manner. The state of the prior art includes such a device where a seam ripper opposes tweezers that are linearly connected to one another through a handle. This solves the problem by reducing the number of tools required, however, it creates the problem of having to flip the tool end over end countless times which leads to more inefficiencies. Because of the number of stitches that often require removal, large amounts of time are still wasted by a sewer or quilter that would be better spent completing other tasks.

The field needs devices and methods that reduce a sewer or quilters time in removing stitches where the user can easily switch between ripping threads and removing threads without having to change tools or flip a tool end over end. Such devices and methods are disclosed herein.

### SUMMARY

In one aspect a stitch remover is disclosed. In various embodiments, the stitch remover may include a thread cutter, a thread remover, and a connecting region for bringing the thread cutter into physical contact with the thread remover and allowing the stitch remover to actuate between a first position and a second position. In various embodiments, the thread cutter further comprises a base and a projection wherein the base includes a first end and a second end and the projection includes a first end and a second end, wherein the first end of the projection is joined to the second end of the base at an interface, and wherein the first end of the base includes an attachment region. In various embodiments, the base and the projection may be a single, contiguous component. In various embodiments, the base and the projection may be separate joined components. In various embodiments, the interface may include a weld, a pin, a screw, or an adhesive. In various embodiments, the second end of the projection may include a blade projection having a point and a safety projection having a safety feature, wherein the blade projection and the safety projection may be in physical contact through a recessed blade. In various embodiments, the first end of the thread remover may include a joined region and an attachment region. In various embodiments, the first end of a flexible first projection may be joined to a first projection of a second flexible projection at a joined region. In various embodiments, the flexible first projection may include a second end having a pad and the flexible second projection may include a second end having a pad wherein the pads oppose one another. In various embodiments, the flexible first projection and the flexible second projection may be made from an elastic material that may be designed to allow the pads to come into contact in a first position and extend away from one another in a second position. In various embodiments, the connecting region may include a connector that projects through an opening in and attachment region of the thread cutter and an opening in an attachment region of the thread remover to rotationally secure the thread cutter and the thread remover to one another. In various embodiments, the connector may include a post, pin, screw, nail, welds, adhesive, or tacks. In various embodiments, the connector may include a first end and a second end and the first end of the connector may be joined to a first coupler and the second end of the connector may be joined to a second coupler. In various embodiments, the first coupler may be in physical contact with a first surface of the thread cutter at or near the attachment region of the thread cutter and the second coupler may be in physical contact with the second surface of the thread remover at or near the attachment region of the thread remover. In various embodiments, the couplers may include screw heads, welds, adhesive, or tacks. In various embodiments, the connection region may include a spacer having a first surface and an opposing second surface, wherein first surface may be in physical contact with a first surface of the thread remover at or near the attachment region and the second surface of the space may be in physical contact with a second surface of the thread cutter at or near the attachment region.

In one aspect a stitch remover is disclosed. In various embodiments, a thread cutter may include a first end and a second end, wherein the first end of the thread cutter may include an attachment region having an opening, a thread remover may include a first end and a second end, wherein the thread remover may have an attachment region having an opening, and a connector that projects through the openings, rotationally connecting the thread cutter and thread remover. In various embodiments, the connector may include a first end attached to a first coupler and a second end attached to a second coupler.

In one aspect a stitch remover is disclosed. In various embodiments, a thread cutter may include an opening, a thread remover may include an opening, and a post projecting through the openings bringing the thread cutter and thread remover into physical contact. In various embodiments, wherein the post may be secured in a manner that allows a surface on the thread cutter to move relative to a surface on the thread remover.

In one aspect a method of removing a stitched seam from fabric is disclosed. In various embodiments, the steps may include providing a stitch remover in a first position, wherein the stitch remover includes: a thread cutter, a thread remover, and a connecting region and actuating the connecting region to move the stitch remover into a second position. In various embodiments, the first position is a closed position and the second position is an open position. In various embodiments, the method further comprises the step of inserting a point of the thread cutter between a thread and a fabric. In various embodiments, the method further includes the step of cutting through the thread using a recessed blade. In various embodiments, the method further includes the step of removing the cut thread using pads on the thread remover. In various embodiments, the connecting region may include a connector joining the thread cutter and the thread remover. In various embodiments, the thread cutter and the thread remover may rotate relative to each other through the connector. In various embodiments, the connector projects through an opening in an attachment region of the thread cutter and an opening in an attachment region of the thread remover to secure the thread cutter and the thread remover to one another. In various embodiments, the connection region may include a spacer having a first surface and an opposing second surface, wherein first surface may be in physical contact with a first surface of the threader remover at or near the attachment region and the second surface of the space may be in physical contact with a second surface of the thread cutter at or near the attachment region.

In one aspect, a method of manufacturing a stitch remover is disclosed. In various embodiments, the method of manufacture may include the steps of providing a thread cutter including an attachment region, providing a thread remover including an attachment region, and connecting the attachment region of the thread cutter to the attachment region of the thread remover at a connection region, wherein the connection region provides rotational movement of the thread cutter and the thread remover relative to one another. In various embodiments, the method of manufacture may further comprise the step of inserting a spacer between the attachment region of the thread remover and the attachment region of the thread cutter. In various embodiments, the connecting region includes a connector that projects through an opening in and attachment region of the thread cutter and an opening in an attachment region of the thread remover to secure the thread cutter and the thread remover to one another. In various embodiments, the method of manufacture may further include the step of attaching a first coupler to a first end of the connector and attaching a second coupler to the second end of the connector. In various embodiments, the stitch remover further may include a screw, a cap, a rivet, a weld, and adhesive, or a pin. In various embodiments, the connector may include a post, a screw, a pin, or a nail. In various embodiments, the rotational movement occurs around the connector.

### BRIEF DESCRIPTION OF THE DRAWINGS

For a more complete understanding of the principles disclosed herein, and the advantages thereof, reference is now made to the following descriptions taken in conjunction with the accompanying drawings in which:

FIG. 1. is an illustration of a stitch remover in an open configuration and including a thread cutter and thread remover according to one of various embodiments.

FIG. 2 is an illustration of a thread cutter according to one of various embodiments.

FIG. 3 is an illustration of a thread remover according to one of various embodiments.

FIG. 4. is an illustration of a connecting region according one of various embodiments.

FIG. 5 is an illustration of a stitch remover in an exploded view according to one of various embodiments.

FIG. 6 is an illustration of a stitch remover in a closed configuration according to one of various embodiments.

FIG. 7 is a flow diagram illustrating a method of use according to one of various embodiments.

FIG. 8 is a flow diagram illustrating a method of use according to one of various embodiments.

FIG. 9 is a flow diagram illustrating a method of manufacture according to one of the various embodiments.

While the present teachings are described in conjunction with various embodiments, it is not intended that the present teachings be limited to such embodiments. On the contrary, the present teachings encompass various alternatives, modifications, and equivalents, as will be appreciated by those skilled in the art.

Furthermore, in describing various embodiments, the specification may present a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one of skill in the art can readily appreciate that the sequences may be varied and still remain within the spirit and scope of the various embodiments.

### Certain Definitions

Approximately or about: As used herein, the term “approximately” or “about,” as applied to one or more values of interest, refers to a value that is similar to a stated reference value. In general, those skilled in the art, familiar within the context, will appreciate the relevant degree of variance encompassed by “about” or “approximately” in that context. For example, in some embodiments, the term “approximately” or “about” may encompass a range of values that are within 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, 1%, or less of the referred value.

Physical contact: As used herein, the term “physical contact” as applied refers to objects either being in direct physical contact or contact through an intermediary. The intermediary being one or more additional physical objects.

### DETAILED DESCRIPTION OF CERTAIN EMBODIMENTS

Embodiments of systems, methods of use, methods of manufacture, and apparatuses for stitch removal (e.g. thread cutting and thread removal) from fabric are described in the accompanying description and figures. In the figures, numerous specific details are set forth to provide a thorough understanding of certain embodiments. A skilled artisan will be able to appreciate that the packing and transportation system described herein can be used in a variety of ways and circumstances, not limited, to what is specifically detailed. Additionally, the skilled artisan will appreciate that certain embodiments may be practiced without these specific details. Furthermore, one skilled in the art can readily appreciate that the specific sequences in which methods are presented and performed are illustrative and it is contemplated that the sequences can be varied and still remain within the spirit and scope of certain embodiments.

While the present teachings are described in conjunction with various embodiments, it is not intended that the present teachings be limited to such embodiments. On the contrary, the present teachings encompass various alternatives, modifications, and equivalents, as will be appreciated by those skilled in the art.

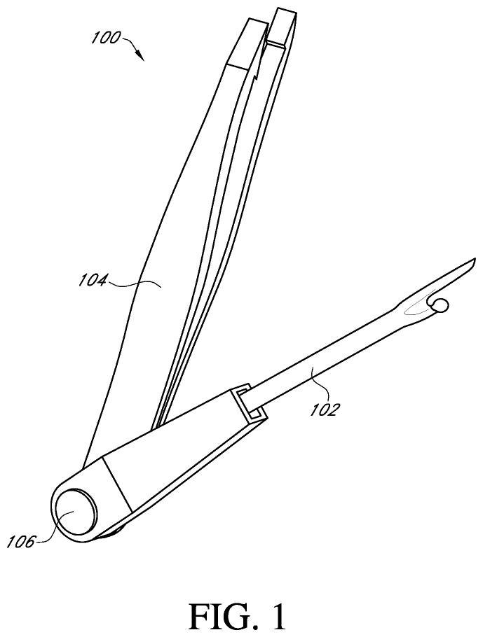

Referring to FIG. 1, a depiction of a stitch remover 100 is shown according to an embodiment. In various embodiments, the stitch remover 100 may include a threat cutter 102 and a thread remover 104 rotationally connected by a connecting region 106.

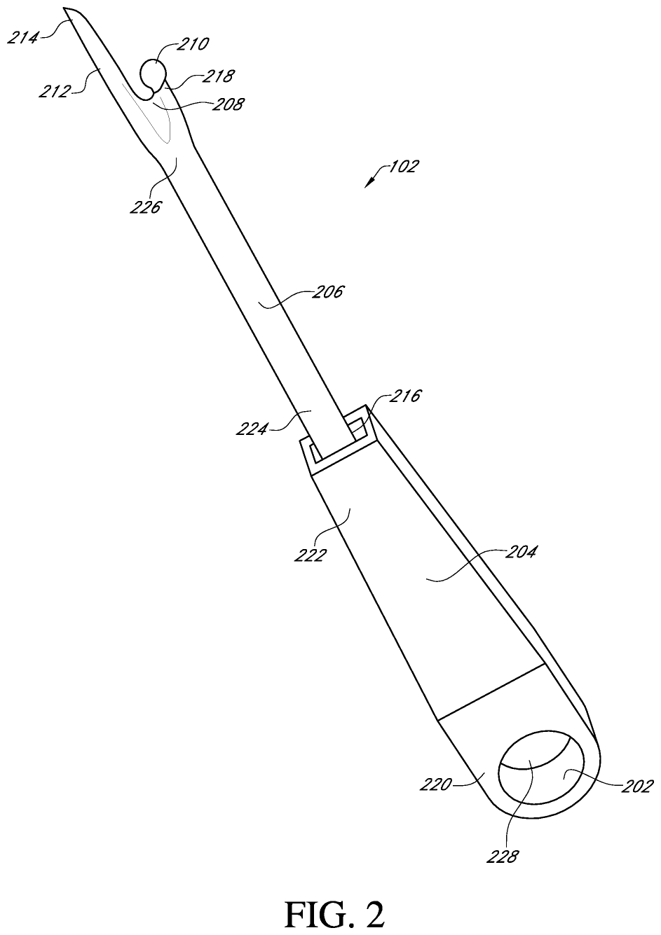

Referring to FIG. 2, a depiction of a thread cutter 102 is shown according to an embodiment. In various embodiments, the thread cutter 102 may include a projection 204 having a first end 224 and a second end 226 and a base 204 having a first end 220 and a second end 222. In various embodiments, the second end 222 of the base 204 may be connected to the first end 224 of the projection at an interface 216. In various embodiments, the projection 206 and the base 204 may be one integrated, solid or continuous piece of material and not include an interface. In various embodiments, the base 204 may include an attachment region 202 located at or near a first end 220 of the base 204. In various embodiments, the attachment region 202 may be solid. In various embodiments, the attachment region may include an opening 228. In various embodiments, the projection 206 may include a second end 226 and at or near the second end 226 a blade projection 212 and a safety projection 218 may extend away from the projection 206 and base 204. In various embodiments, the blade projection 212 may include a point 214. In various embodiments, the safety projection 218 may include a safety feature 210. In various embodiments, the blade projection 212 and the safety projection 218 may be connected by a recessed blade 208. In various embodiments, the recessed blade may be sharpened to easily cut thread.

In various embodiments, the base 204 may be adapted so that a sewer or quilter can easily grip the base. In various embodiments, the base may comprise a metallic material. In various embodiments, the metallic material may be wrapped in plastic, silicone, or some other easy to grip material. In various embodiments, the base 204 may comprise carved wood.

In various embodiments, the projection 206 may be secured to the base 204 with a tack, nail, pin, weld, adhesive or some other securing device at or near the interface 216. In various embodiments, the projection 206 and base 204 may be a solid piece of material and not require a securing device. In various embodiments, the interface may include a weld, a pin, a screw, or an adhesive.

In various embodiments, the thread cutter may resemble or be a seam ripper device.

In various embodiments, the safety feature 210 may include plastic or silicone affixed to the safety projection 218. In various embodiments, the safety feature 210 may be made from the same material as the safety projection and be one contiguous, solid piece of material. In various embodiments, the safety feature 210 may include a blunt object. In various embodiments, the safety feature 210 may be ovular or spherical in shape.

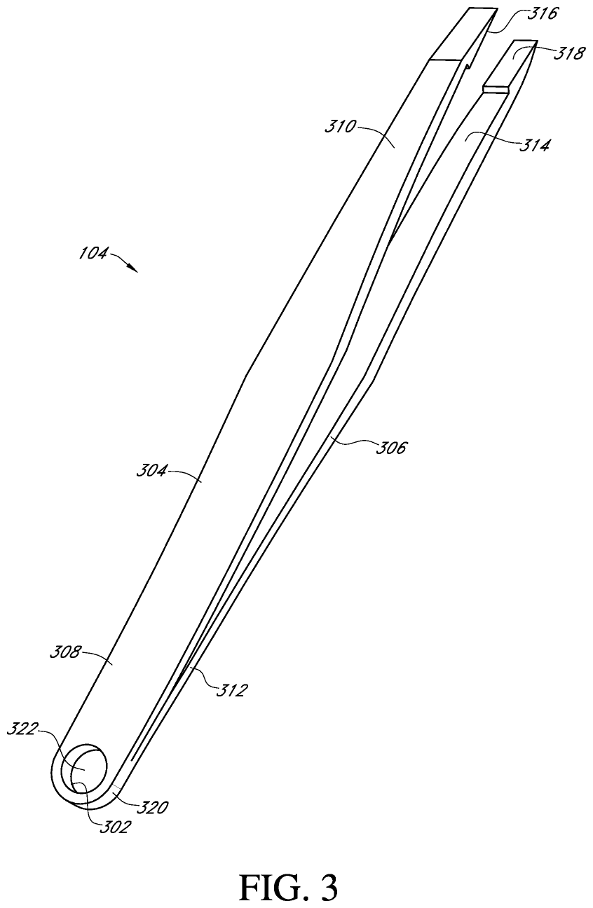

Referring to FIG. 3, a depiction of a thread remover 104 is shown according to an embodiment. In various embodiments, the thread remover 104 may include a first flexible projection 304 and a second flexible projection 306 connected at a joined region 320. In various embodiments, the first flexible projection 304 may include a first end 308 and a second end 310 and the second flexible projection 306 may include a first end 312 and a second end 314. In various embodiments, the first end 308 of the first flexible projection 304 may be joined to the first end 312 of the second flexible projection 306 at the joined region 320. In various embodiments, the joined region 320 may include an attachment region 302. In various embodiments, the attachment region 302 may include an opening 322. In various embodiments, the attachment region may be solid and not include an opening. In various embodiments, the first flexible projection 304 may include a second end 310 and the second end 310 may include a pad 316. In various embodiments, the second flexible projection 306 may include a second end 314 and the second end 314 may include a pad 318.

In various embodiments, the thread remover 104 may be adapted so that each of the flexible projections 304 306 flex when a sewer or quilter applies pressure. In various embodiments, when pressure is applied to the flexible projections 304 306 the pads 316 318 come into contact with one another. In various embodiments, the contacting pads 316 318 are adapted to grasp threads. In various embodiments, the thread remover 104 or a portion thereof is made from an elastic material and such that the pads 316 318 may repeated come into contact with one another than then retract when pressure is removed from the flexible projections 304 306.

In various embodiments, the thread remover 104 may be made from a single piece of material. In various embodiments, the flexible projections 304 306 may be separate pieces and the joined region 320 may include a tack, weld, screw, adhesive, or any other securing implement known in the field.

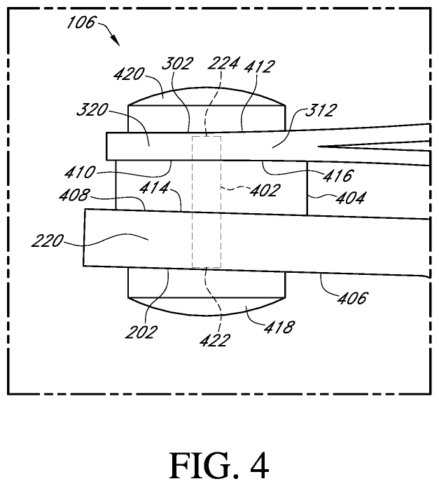

Referring to FIG. 4, a depiction of a connecting region 106 is shown according to an embodiment. In various embodiments, an attachment region 202 of the thread cutter 102 and an attachment region 302 of the thread remover 304 may be in physical contact either directly or through an intermediary.

In various embodiments, the connecting region 106 may include a spacer 404 as an intermediary. In various embodiments, the spacer 404 may include a first surface 414 abutting a first surface 410 of the joined region 320 or attachment region 302 of the thread remover 104. In various embodiments, the spacer 404 may include a second surface 416 abutting a second surface 408 of the attachment region 202 of the thread cutter 102.

In various embodiments, a connector 402 may span the length of the connecting region 106 (e.g. the thread cutter 102, thread remover 104, and spacer 404). In various embodiments, the connector 402 may project through the openings 228 320 and be secured by couplers 418 420. In various embodiments, the first coupler 418 may secure a first end 422 of the connector 402 at or near a first surface of the attachment region 202 of the thread cutter. In various embodiments, the second coupler 420 may secure a second end 224 of the attachment region 302 at the attachment region 302 of the thread remover 104. In various embodiments, the connector may include a post, pin, screw, nail, welds, adhesive, or tacks. In various embodiments, the couplers may include screw heads, welds, adhesive, or tacks.

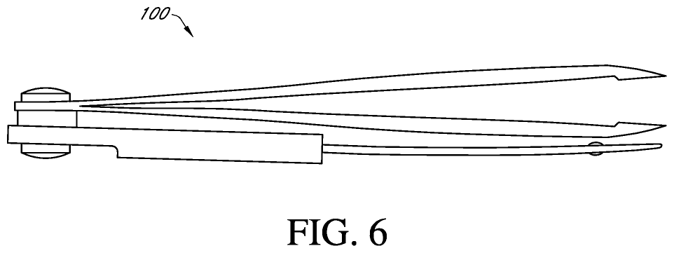

In various embodiments, the purpose of the connecting region 106 is not simply to affix the thread remover 104 to the thread cutter 102, but to allow the thread remover 104 and the thread cutter 102 to move relative to each other. Such a configuration allows a sewer or quilter to move the tools into a custom position for their particular hand structure or for a specified application. In various embodiments, the thread cutter 102 and the thread remover 104 move along the same plane. In various embodiments, the spacer 404 is made from a material that facilitates easy rotation. In some embodiments, the thread cutter 102 and the thread remover 104 may be made from a metallic material and the spacer 404 may be made from silicone or plastic, thereby, allowing easy rotation from a closed position shown in FIG. 6 to an open position shown in FIG. 1.

In various embodiments, the spacer 404 may space the thread remover 104 apart from the thread cutter 102 such that they do not obstruct each other when a sewer or quilter rotates the stitch remover 100 include a closed position. In various embodiments, the spacer 404 prevents metal on metal contact between the thread remover 104 and the thread cutter 102, thereby allowing easier rotation and extending the useful life of the stitch remover 100.

A skilled artisan will appreciate that the kind of rotation disclosed herein may allow for the stitch remover 100 to actuate between one, two, three, four, or any number of positions based on a sewer or quilters physical attributes and the task being performed.

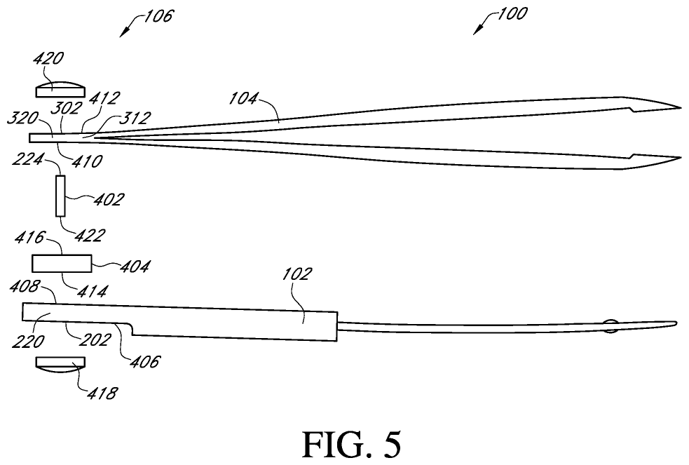

Referring to FIG. 5, a depiction of the stitch remover 100 is shown in an exploded view to exemplify the individual components according to the embodiment in FIG. 4.

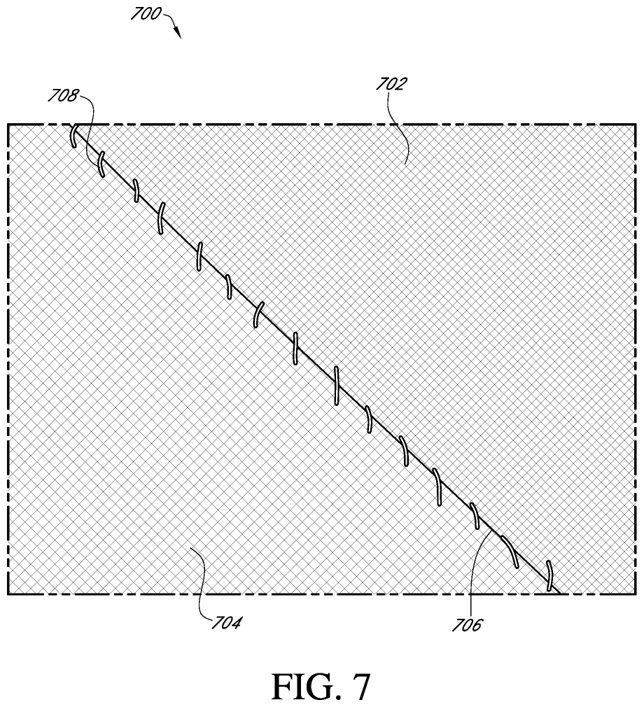

Referring to FIG. 7, a depiction of a stitched fabric 700 according to one embodiment. In various embodiments, the stitch remover 100 is designed to be used to remove stitching 708 joining a first fabric 702 to a second fabric 704 along a seam 706. In various embodiments, the stitching may include thread.

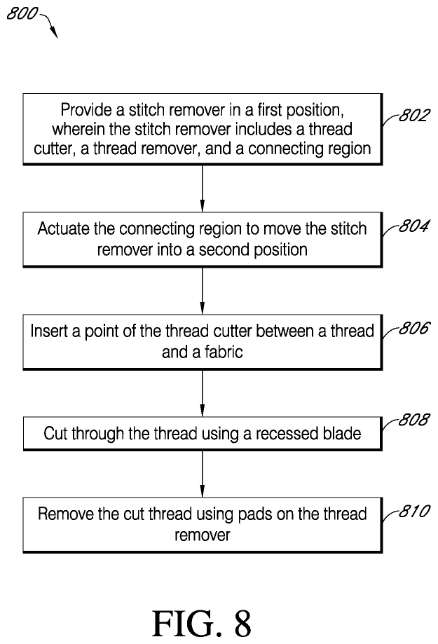

Referring to FIG. 8, a depiction of an exemplary flowchart showing a method 800 of removing a stitched seam from fabric is disclosed according to an embodiment. In step 802, a stitch remover is provided in a first position, wherein the stitch remover may include a thread cutter, a thread remover, and a connecting region. In step 804, a connecting region may be actuated to move the stitch remover into a second position. In step 806, a point of the thread cutter may be inserted between a thread and a fabric. In step 808, a recessed blade may cut through the thread. In step 810, pads on the thread remover may remove the cut thread.

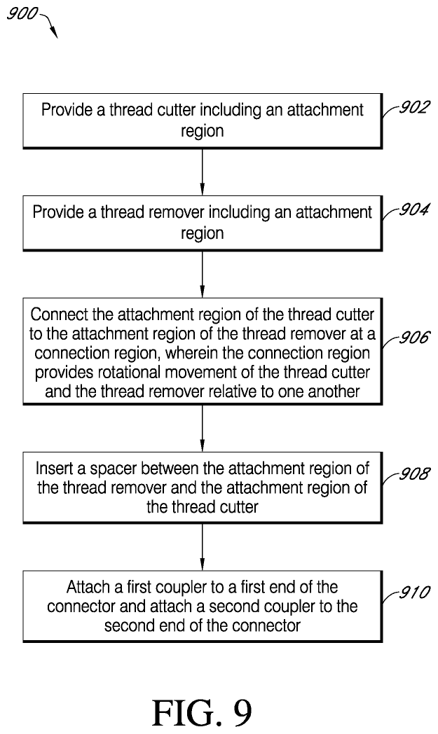

Referring to FIG. 9, a depiction of an exemplary flowchart showing a method 900 of manufacturing a stitch remover is disclosed. In step 902, a thread cutter including an attachment region is provided. In step 904, a thread remover including an attachment region is provided. In 906, the attachment region of the thread cutter is connected to the attachment region of the thread remover at a connection region, wherein the connection region may provide rotational movement of the thread cutter and the thread remover relative to one another. In step 908, A spacer may be inserted between the attachment region of the thread remover and the attachment region of the thread cutter. In step 910, a first coupler may be attached to the first end of the connector and a second coupler may be attached to the second end of the connector.

In various embodiments, the method may include assembling a base 204 onto the thread cutter 102 or thread remover 104 for ergonomic purposes. In various embodiments, the method of manufacture may include welding, pinning, screwing, or applying adhesive to the interface 216 or attachment regions 202 302. In various embodiments, the method of manufacture may include sharpening the recessed blade 208. In various embodiments, the method of manufacture may include the step of joining the first flexible projection 304 to the second flexible projection 306 at the joined region 320. The step of joining may use a weld, adhesive, pin, hook, or any other known attachment device or process. In various embodiments, the method of manufacture may include producing pads 316 318 on the second ends 310 314 of the first flexible projection 304 and the second flexible projection 306.

In various embodiment, the stitch remover 100 may actuate or fold from an open position (FIG. 1) to a closed position (FIG. 6) or to any position in between. In various embodiments, the thread cutter 102 and the thread remover 104 may be able to swivel or rotate a full 360 degrees from a closed position back to a closed position. Such versatility not only allows for easy storage, but also allows sewers and thread artists having different physical characteristics to optimize the angle between the thread cutter 102 and the thread remover 104 to maximize efficiency or to adjust the angle based on a given project. In various embodiments, projects may vary by fabric type or stitching pattern.

### EQUIVALENCE

Those skilled in the art will recognize or be able to ascertain using no more than routine experimentation, many equivalents to the specific embodiments of the invention described herein. It is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. Further, it should also be understood that any embodiment or aspect of the invention can be explicitly excluded from the claims, regardless of whether the specific exclusion is recited in the specification. The scope of the present invention is not intended to be limited to the above Description, but rather is as set forth in the claims that follow.

What is claims:

1. A stitch remover, comprising:
a thread cutter,
a thread remover; and
a connecting region for bringing the thread cutter into physical contact with the thread remover and allowing the stitch remover to actuate between a first position and a second position.

2. The stitch remover of claim 1, wherein the thread cutter further comprises a base and a projection,
wherein the base includes a first end and a second end and the projection includes a first end and a second end,
wherein the first end of the projection is joined to the second end of the base at an interface, and
wherein the first end of the base includes an attachment region.

3. The stitch remover of claim 2, wherein the base and the projection are a single, contiguous component.

4. The stitch remover of claim 2, wherein the base and the projection are separate joined components.

5. The stitch remover of claim 4, wherein the interface includes a weld, a pin, a screw, or an adhesive.

6. The stitch remover of claim 5, wherein the second end of the projection includes a blade projection having a point and a safety projection having a safety feature, wherein the blade projection and the safety projection are in physical contact through a recessed blade.

7. The stitch remover of claim 6, wherein the first end of the thread remover includes a joined region and an attachment region.

8. The stitch remover of claim 7, wherein the first end of a flexible first projection is joined to a first projection of a second flexible projection at a joined region.

9. The stitch remover of claim 8, wherein the flexible first projection includes a second end having a pad and the flexible second projection includes a second end having a pad wherein the pads oppose one another.

10. The stitch remover of claim 9, wherein the flexible first projection and the flexible second projection are made from an elastic material that are designed to allow the pads to come into contact in a first position and extend away from one another in a second position.

11. The stich remover of claim 10, wherein the connecting region includes a connector that projects through an opening in and attachment region of the thread cutter and an opening in an attachment region of the thread remover to rotationally secure the thread cutter and the thread remover to one another.

12. The stitch remover of claim 11, wherein the connector is a post, pin, screw, nail, welds, adhesive, or tacks.

13. The stitch remover of claim 12, wherein the connector includes a first end and a second end and the first end of the connector is joined to a first coupler and the second end of the connector is joined to a second coupler.

14. The stitch remover of claim 13, wherein the first coupler is in physical contact with a first surface of the thread cutter at or near the attachment region of the thread cutter and the second coupler is in physical contact with the second surface of the thread remover at or near the attachment region of the thread remover.

15. The stitch remover of claim 13, wherein the couplers include screw heads, welds, adhesive, or tacks.

16. The stich remover of claim 14, wherein the connection region includes a spacer having a first surface and an opposing second surface, wherein first surface is in physical contact with a first surface of the thread remover at or near the attachment region and the second surface of the space is in physical contact with a second surface of the thread cutter at or near the attachment region.

17. A stitch remover, comprising:
a thread cutter including a first end and a second end, wherein the first end of the thread cutter includes an attachment region having an opening;
a thread remover including a first end and a second end, wherein the thread remover has an attachment region having an opening; and
a connector that projects through the openings, rotationally connecting the thread cutter and thread remover.

18. The stich remover of claim 17, wherein the connector includes a first end attached to a first coupler and a second end attached to a second coupler.

19. A stitch remover, comprising:
a thread cutter including an opening;
a thread remover including an opening; and
a post projecting through the openings bringing the thread cutter and thread remover into physical contact.

20. The stitch remover of claim 19, wherein the post is secured in a manner that allows a surface on the thread cutter to move relative to a surface on the thread remover.

21. A method of removing a stitched seam from fabric, comprising the steps of:
providing a stitch remover in a first position, wherein the stitch remover includes:
a thread cutter;
a thread remover;
a connecting region; and
actuating the connecting region to move the stitch remover into a second position.

22. The method of claim 21, wherein the first position is a closed position and the second position is an open position.

23. The method of claim 22, further comprising the step of inserting a point of the thread cutter between a thread and a fabric.

24. The method of claim 23, further comprising the step of cutting through the thread using a recessed blade.

25. The method of claim 24, further comprising the step of removing the cut thread using pads on the thread remover.

26. The method of claim 25, wherein the connecting region includes a connector joining the thread cutter and the thread remover.

27. The method of claim 26, wherein the thread cutter and the thread remover rotate relative to each other through the connector.

28. The method of claim 27, wherein the connector projects through an opening in an attachment region of the thread cutter and an opening in an attachment region of the thread remover to secure the thread cutter and the thread remover to one another.

29. The method of claim 28, wherein the connection region includes a spacer having a first surface and an opposing second surface, wherein first surface is in physical contact with a first surface of the threader remover at or near the attachment region and the second surface of the space is in physical contact with a second surface of the thread cutter at or near the attachment region.

30. A method of manufacturing a stitch remover, comprising the steps of:
providing a thread cutter including an attachment region;
providing a thread remover including an attachment region; and
connecting the attachment region of the thread cutter to the attachment region of the thread remover at a connection region, wherein the connection region provides rotational movement of the thread cutter and the thread remover relative to one another.

31. The method of manufacturing the stitch remover in claim 30, further comprising the step of inserting a spacer between the attachment region of the thread remover and the attachment region of the thread cutter.

32. The method of manufacturing the stitch remover of claim 31, wherein the connecting region includes a connector that projects through an opening in and attachment region of the thread cutter and an opening in an attachment region of the thread remover to secure the thread cutter and the thread remover to one another.

33. The method of manufacturing the stitch remover of claim 33, further comprising the step of attaching a first coupler to a first end of the connector and attaching a second coupler to the second end of the connector.

34. The method of manufacturing the stitch remover of claim 33, wherein the couplers include a screw, a cap, a rivet, a weld, and adhesive, or a pin.

35. The method of manufacturing the stitch remover of claim 34, wherein the connector includes a post, a screw, a pin, or a nail.

36. The method of manufacturing the stitch remover of claim 35, wherein rotational movement occurs around the connector.
